(19) United States
(12) Patent Application Publication
(10) Pub. No.: US 2011/0100773 A1
(43) Pub. Date: May 5, 2011

(54) DISC BRAKE

(75) Inventors: Kishio Hidaka, Hitachiota (JP); Kazuya Baba, Hitachi (JP); Makoto Ebihara, Hitachi (JP)

(73) Assignee: Hitachi Chemical Company, Ltd.

(21) Appl. No.: 12/914,073

(22) Filed: Oct. 28, 2010

(30) Foreign Application Priority Data
Oct. 30, 2009 (JP) 2009-249660

(51) Int. Cl. F16D 65/12

(52) U.S. Cl. 188/218 XL

(57) ABSTRACT

A rotor main body 1 (disc brake), which is made of a C/SiC composite material and provided with a bolt joint around a center axis of the disc brake, of a brake rotor R1. The bolt joint is formed by embedding a block body 13, which is formed by winding carbon fibers into a cylindrical shape, in the disc brake. The strength of the bolt joint which fastens the rotor main body 1 to, for example, a hat portion can be increased.

### CROSS REFERENCE TO RELATED APPLICATIONS

This application claims the foreign priority benefit under Title 35, United States Code, §119(a)-(d) of Japanese Patent Application No. 2009-249660, filed on Oct. 30, 2009, the contents of which are hereby incorporated by reference.

### BACKGROUND OF THE INVENTION

1. Field of the Invention

The present invention relates to a disc brake to be used for, for example, a brake rotor and a clutch disc and, more particularly, to the disc brake made of a C/SiC composite material.

2. Description of Related Art

Up to now, a brake rotor for a vehicle using a disc brake made of the C/SiC composite material (Carbon/Silicon and Carbide composite material) has been known (see, for example, Japanese Patent Laid-Open Publication No. 2003-522709).

The disc brake is manufactured in such a manner that a near-net shape molded product is obtained by molding a composition containing carbon fibers and an organic binder within a die, and subsequently, the molded product which is carbonized by burning thereof is impregnated with a molten Si for partially silicon-carbide formed the carbon.

A method for manufacturing the disc brake is easy because the silicon-carbide formation of the carbonized product progresses according to a melting temperature of Si, and the obtained disc brake is further superior in heat resistance and abrasion resistance in comparison with a disc brake made of a C/C composite material.

However, in a conventional brake rotor (see, for example, Japanese Patent Laid-Open Publication No. 2003-522709) using the C/SiC composite material for a disc brake, a hat portion which fixes the disc brake to a hub of a wheel is a discrete member. This is different from a brake rotor whose disc brake is formed by, for example, casting. Therefore, in the disc brake made of the C/SiC composite material, a bolt insertion hole for fastening the hat portion to the disc brake is disposed around the center axis of the disc brake. Then, when the brakes are applied, that is, when a brake pad frictionally slides, a large stress concentrates on a bolt joint, where the bolt insertion hole is disposed, in the disc brake of the conventional brake rotor (see, for example, Japanese Patent Laid-Open Publication No. 2003-522709). Consequently, a disc brake having a sufficient strength against a large stress which concentrates on the bolt joint when applied the brakes has been expected.

It is, therefore, an object of the present invention to provide a disc brake which is made of the C/SiC composite material, and which is further superior in strength in comparison with the conventional one.

### SUMMARY OF THE INVENTION

According to the present invention which solves the foregoing problems, there is provided a disc brake which is made of a C/SiC composite material and is provided with a bolt joint around a center axis of the disc brake. The bolt joint is formed by embedding a block body, which is formed by winding carbon fibers into a cylindrical shape, in the disc brake.

According to the present invention, a disc brake which is made of the C/SiC composite material, and which is further superior in strength in comparison with the conventional one can be provided.

### BRIEF DESCRIPTION OF THE DRAWINGS

FIG. 1A is a plane view of a brake rotor using a disc brake according to an embodiment of the present invention;

FIG. 1B is a cross sectional view of FIG. 1A taken along I-I line;

FIG. 2 is a partial perspective view showing a close aspect of a block body as seen from a II direction in FIG. 1A and FIG. 1B;

FIG. 3A and FIG. 3B are illustrations each showing a thermal stress distribution of a thermal stress to be generated in a block body of a rotor main body when applied the brakes, which are results calculated by simulation tests;

FIG. 4A and FIG. 4B are illustrations of a torque stress distribution of a torque stress to be generated in a block body of a rotor main body when applied the brakes, which are results calculated by a simulation test;

FIG. 5A is a plane view of a brake rotor using a disc brake according to another embodiment of the present invention; and

FIG. 5B is a cross sectional view of FIG. 5A taken along V-V line.

### DETAILED DESCRIPTION OF THE PREFERRED EMBODIMENT

Hereinafter, an embodiment of the present invention will be explained in detail by referring to drawings as appropriate. A disc brake of the present invention may be applied to the disc brake used for, for example, a brake rotor and a clutch disc. However, in the embodiment, the disc brake used for the brake rotor for a vehicle will be explained.

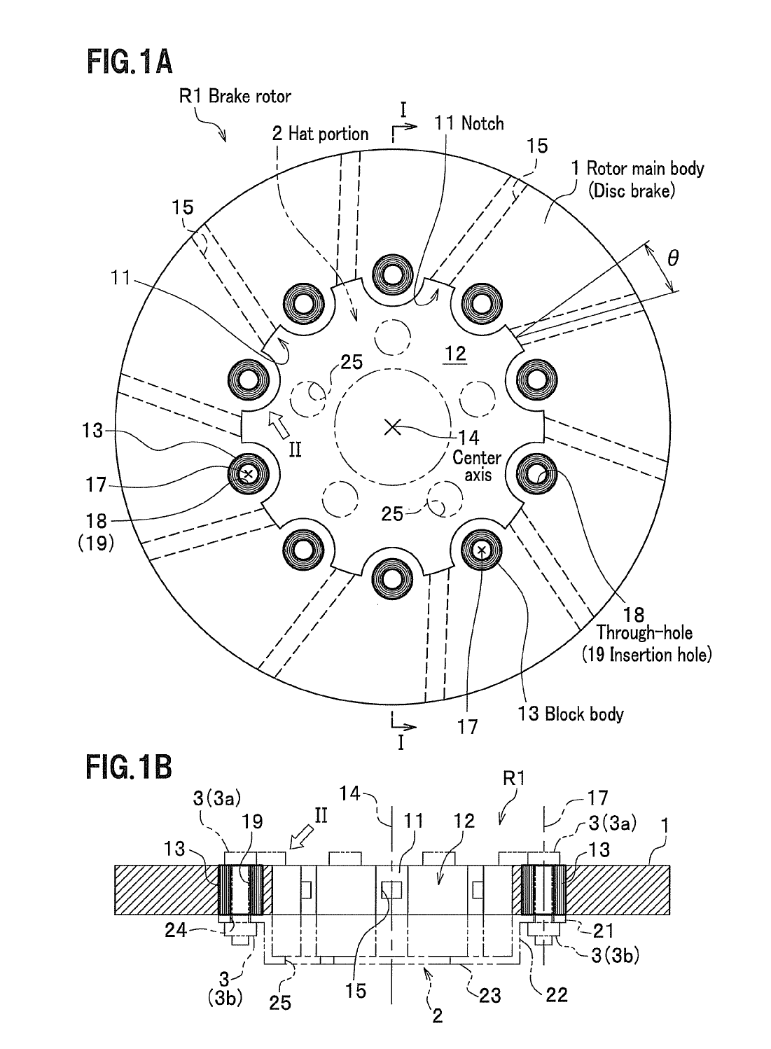

As shown in FIG. 1A and FIG. 1B, a brake rotor R1 includes a rotor main body 1 as the disc brake of the present invention and a hat portion 2. It is noted that in FIG. 1A, the hat portion 2 is shown with an imaginary line, and a fastening tool 3 for fastening the hat portion 2 to the rotor main body 1 is omitted for convenience of drawing. In addition, in FIG. 1B, the hat portion 2 and the fastening tool 3 (bolt 3a and nut 3b) are shown with imaginary lines.

The rotor main body 1 has a center hole 12 having a schematic circular shape in planar view and is made of a C/SiC composite material.

In the rotor main body 1, a cylindrical block body 13 is arranged at ten points at regular intervals along a periphery portion surrounding the center hole 12. The block body 13 constitutes a bolt joint for fastening the hat portion 2 together with the fastening tool 3. Namely, the rotor main body 1 according to the embodiment is provided with a plurality of block bodies 13 (bolt joint) around a center axis 14 of the rotor main body 1.

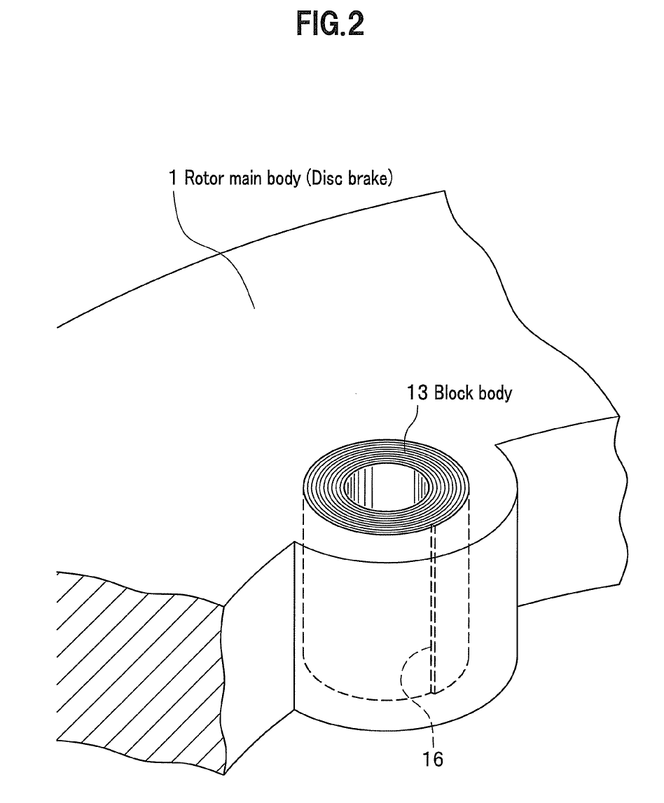

The block body 13 is a winding of carbon fibers tape, and as shown in FIG. 2, has a cylindrical shape having a height identical to a thickness of the rotor main body 1. In the embodiment, the block body 13 is formed by winding a tape of fiber bundle 16 of carbon fibers formed in a tape, and a width of the tape fiber bundle 16 is set substantially identical to the thickness of the rotor main body 1.

As shown in FIG. 1B, the block body 13 is arranged so that a winding axis 17 of carbon fibers is aligned along the center axis 14 of the rotor main body 1. In other words, the block body 13 is embedded in the rotor main body 1 so that the winding axis 17 of carbon fibers becomes perpendicular to a disc surface of the rotor main body 1, and an end of the embedded block body 13 becomes identical to a surface of the rotor main body 1.

The block body 13 includes a through-hole 18 (see FIG. 1A) whose center corresponds to the winding axis 17 of carbon fibers tape, and the through-hole 18 forms an insertion hole 19 of the bolt 3a (see FIG. 1B). Namely, the block body 13, in which the insertion hole 19 of the bolt 3a is disposed, is embedded in the rotor main body 1 to form the bolt joint. Meanwhile, the block body 13 according to the embodiment is formed in a cylindrical shape by boring the through-hole 18 at the winding axis 17 (winding center) of carbon fibers, as will be described later.

As shown in FIG. 1A, the rotor main body 1 includes a notch 11 which is formed by partially cutting-out a portion between the block bodies 13 neighboring each other at regular intervals. As shown in FIG. 1A and FIG. 1B, one end of a cooling hole 15 extends to the notch 11.

The cooling hole 15 extends to an outer periphery side of the rotor main body 1 from the notch 11 within substantially a middle portion of the rotor main body 1 in the thickness direction, and the other end of the cooling hole 15 opens at the outer periphery. A cross sectional shape of the cooling hole 15 according to the embodiment has a rectangular shape, as shown in FIG. 1B.

As shown in FIG. 1A, an extending direction of the cooling hole 15 is inclined against a centrifugal direction of the rotor main body 1 at a predetermined inclination angle θ. Since the cooling hole 15 is formed to be inclined as described above, an air flow inside the cooling hole 15 is promoted when the brake rotor R1 rotates, and a friction heat generated in the rotor main body 1 can be effectively cooled, accordingly.

The hat portion 2 is, as shown in FIG. 1B, a member which is arranged so as to cover the center hole 12 of the rotor main body 1 from one side and is fastened to the rotor main body 1 by the fastening tool 3 (bolt 3a and nut 3b), that is, the member for fixing the rotor main body 1 to a hub (not shown) of a wheel.

The hat portion 2 has, as shown in FIG. 1A, a schematic circular shape in planar view and a hat shape in side view.

As shown in FIG. 1B, the hat portion 2 described above includes a flange portion 21 to be fastened to the rotor main body 1, a cylindrical portion 22 rising from the flange portion 21, and a hub fixing portion 23 which is connected to the cylindrical portion 22 and arranged so as to cover the center hole 12 of the rotor main body 1. It is noted that in the flange portion 21, a bolt insertion hole 24 is formed at a position corresponding to the insertion hole 19 of the rotor main body 1, and in the hub fixing portion 23, a bolt insertion hole 25 for fastening the hat portion 2 to the hub (not shown) of the wheel is formed.

Next, a manufacturing method of the rotor main body 1 will be explained.

In the manufacturing method, a winding body of carbon fibers is formed so as to correspond to a shape of the block body 13. It is preferable that the carbon fibers for forming the winding body are, as described above, the carbon fibers (tape fiber bundle 16, see FIG. 2) formed in a tape with a predetermined width.

A method for forming carbon fibers into a tape is such that a fiber bundle consisting of, for example, 12000 to 24000 carbon fibers is reeled out from a roll to spread out, and the fiber bundle which was spread out and formed into a tape is immersed in a synthesis resin solution and wound up. In this case, a surface of each of the carbon fibers which constitute the tape fiber bundle 16 (see FIG. 2) is completely coated with the synthesis resin.

As the synthesis resin, for example, phenol resin, furan resin, polyimide resin, polyallylate resin, and polyurethane resin may be used. Especially, a resol-type phenol resin is preferable. The resol-type phenol resin becomes water-soluble if pH is adjusted between 7.0 and 12.5, and the handling becomes easy.

In the embodiment, the tape carbon fibers (fiber bundle) containing the synthesis resin is wound in a columnar shape or a cylindrical shape, and then, the synthesis resin is cured to form a winding body. The winding body is formed in a near-net shape of an outer shape of the block body 13 shown in FIG. 2. In this case, if the synthesis resin is thermosetting resin, the synthesis resin is heated at a predetermined curing temperature, and if the synthesis resin is thermoplastic resin, the synthesis resin is cured at a temperature below the glass transition temperature.

Next, in the manufacturing method, the winding body is arranged at a position corresponding to the bolt joint within a die of the rotor main body 1. That is, the winding body is arranged at the position of the block body 13 shown in FIG. 1A.

Then, in the manufacturing method, a mixture containing an organic binder and short carbon fibers whose surfaces are coated with the synthesis resin is filled in the die of the rotor main body 1 where the winding body is arranged.

The short carbon fibers may by manufactured by, for example, cutting the resin-coated carbon fibers used for the winding body into pieces in length less than 10 mm.

As the organic binder, for example, phenol resin, furan resin, imide resin, epoxy resin, pitch, and organosilicon-based polymer may be used. The organic binder may be solid, or may be liquid. In addition, the organic binder which has a high carbon yield after thermal decomposition is preferable.

In addition to the carbon fibers and the organic binder, for example, granular graphite, silicon carbide, metallic carbide, and metallic nitride may be added to the mixture.

Next, in the manufacturing method, the winding body arranged in the die and the filled mixture are united within the die under a predetermined temperature and pressure to obtain a molded product having a near-net shape of the outer shape of the rotor main body 1. In this case, if the organic binder is thermosetting resin, the thermosetting resin is heated at a predetermined curing temperature.

Next, in the manufacturing method, the foregoing molded product is burned to carbonize the synthesis resin of the winding body and the organic binder to form a C/C product. The burning process is preferably conducted in an atmosphere of inert gas such as nitrogen and argon at around 900° C.

Next, in the manufacturing method, the C/C product obtained in the foregoing burning process is arranged in a predetermined furnace, and solid silicon is spread thereon. As the solid silicon, for example, granular silicon having a diameter of 1 to 3 mm, or block silicon having a diameter of 10 to 30 mm may be preferably used.

Then, the furnace is heated up to more than 1400° C. in a vacuum in order to melt the solid silicon and impregnate the C/C product with the melted Si. Through this process, the carbonized organic binder reacts with Si to form SiC, and a C/SiC composite material which contains short carbon fibers within a SiC matrix is formed. In this case, the carbonized substance of the coated resin (synthesis resin described above) formed on the surface of the carbon fiber in the foregoing burning process prevents the short carbon fibers contained in the C/C product and the tape fiber bundle from being silicon-carbide formed by contacting with the melted Si. Next, the insertion hole 19 of the bolt 3a is formed in the block body 13 by using a super-hard cutting tool and the outer shape is made up as appropriate to obtain the rotor main body 1 (see FIG. 1A).

Next, operations and effects of the rotor main body 1 (disc brake) according to the embodiment will be explained.

In the rotor main body 1 according to the embodiment, when a braking force is applied to a wheel of a vehicle, a brake pad of a caliper (not shown) is pressed against a disc surface of the rotor main body 1. In this case, a large stress concentrates on the bolt joint which fastens the hat portion 2 to the rotor main body 1, that is, on the block body 13 where the insertion hole 19 of the bolt 13 is formed.

On the other hand, since the block body 13 is formed by winding carbon fibers tape in a cylindrical shape, the block body 13 has a sufficient strength even if a large stress concentrates thereon when applied the brakes. It is supposed that the sufficient strength comes from the following reason that when a load is input to the block body 13 from the bolt 3a, the wound carbon fibers effectively disperse the load.

In addition, in the rotor main body 1 according to the embodiment, since the block body 13 is formed by winding the fiber bundle of the carbon fibers formed in a tape, the carbon fibers are likely to align along a circumferential direction of the cylindrical shape. Therefore, a load input to the block body 13 is further effectively dispersed.

In addition, in the rotor main body 1 according to the embodiment, since the block body 13 is formed by winding the tape fiber bundle 16 which is formed by carbon fibers formed into a tape, the cylindrical shape can be easily formed.

In addition, in the rotor main body 1 according to the embodiment, since the block body 13 is formed by boring the through-hole 18 at the winding center (winding axis 17) of the carbon fibers, the carbon fibers can be prevented from being cut by the though-hole 18. As a result, a strong bolt joint can be formed.

Next, a simulation test for demonstrating the foregoing operations and effects of the rotor main body 1 according to the embodiment was conducted. The results will be explained below.

In the simulation test, a calculation model having a shape identical to the brake rotor R1 shown in FIG. 1B was used, and a thermal stress and a torque stress to be generated in the block body 13 when applied the brakes were calculated.

A calculation of the thermal stress was conducted, assuming a braking condition that when a vehicle mounting the brake rotor R1 is running at 100 km/h, the vehicle stops with a braking time of 9.3 seconds by decelerating the vehicle with 3.0 m/s², as well as setting an initial heat flux of 5.07×10⁵ W/m². A simplified temperature distribution at a time when a fade test of a thermal liquid analysis was completed five times was used for an initial temperature distribution. In addition, no thermal conduction to air was assumed. In the calculation of the thermal stress, as a data of material strength of the bolt 3a, a stress-strain diagram of chrome molybdenum steel which is opened to the public was used.

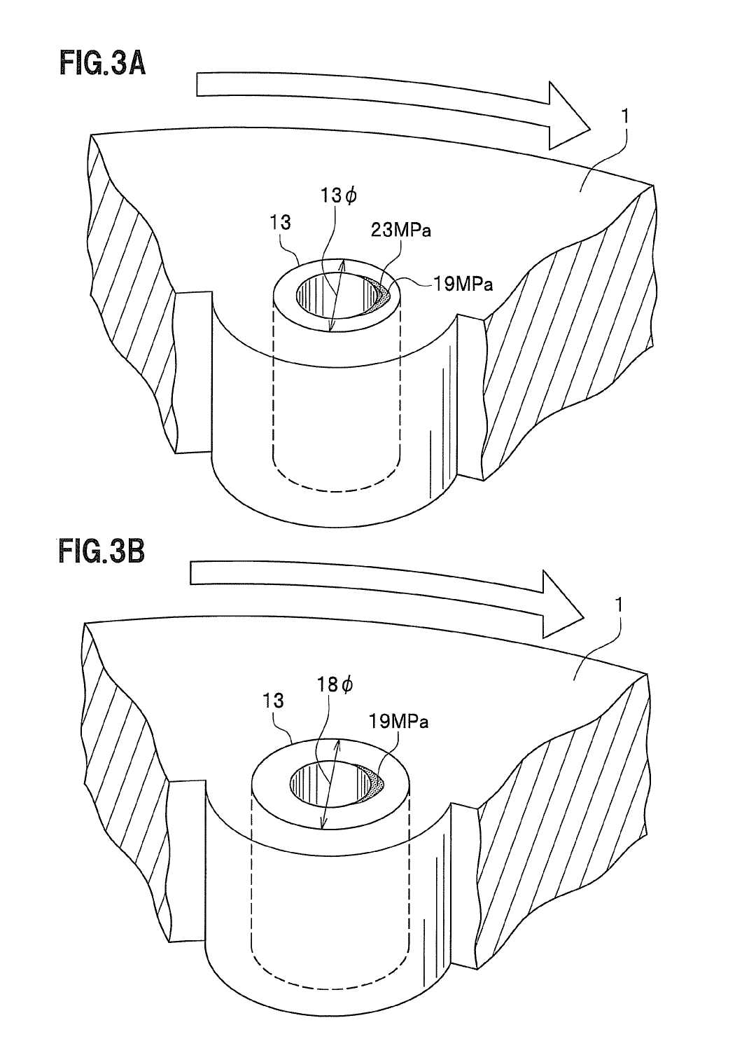

FIG. 3A is a calculation result of a thermal stress distribution 3 seconds after starting the brakes of the brake rotor R1, where the block body 13 has an outer diameter of 13 mm. FIG. 3B is a calculation result of a thermal stress distribution 3 seconds after starting the brakes of the rotor main body 1, where the block body 13 has an outer diameter of 18 mm. Meanwhile, each arrow in FIG. 3A and FIG. 3B indicates a rotation direction of the rotor main body 1 when a vehicle is running, a numerical number 1 indicates the rotor main body, and a numerical number 13 indicates the block body.

As shown in FIG. 3A, a maximum value of the thermal stress of the rotor main body 1 whose block body 13 has the outer diameter of 13 mm was 23 MPa. On the other hand, as shown in FIG. 3B, a maximum value of the thermal stress of the rotor main body 1 whose block body 13 has the outer diameter of 18 mm was 19 MPa.

Namely, it was demonstrated that a thermal stress and a thermal strain during the braking decrease as the diameter of the block body 13 increases. In other words, it was demonstrated that the thermal stress and the thermal strain decrease as a volume of the block body 13 increases.

With respect to the calculation of a torque stress, it was assumed that a stress of the brake pad against the rotor main body 1 was 5.89 MPa, assuming that a torque of three times of a rated torque was added, and that a shear stress of 2.65 MPa was generated in a circumferential direction of the rotor main body 1. In the calculation of the torque stress, an outer diameter and an inner diameter of the hat portion 2 were set to 194 mm and 110 mm, respectively, and the stress-strain diagram of chrome molybdenum steel which is opened to the public was used as a data of material strength of the hat portion 2 and the bolt 3a.

Meanwhile, it was assumed that the hat portion 2 shows elasticity and the bolt 3a shows elasto-plasticity. In the analysis, a whole deformation of the rotor main body 1 was calculated, and a displacement at the deformation was given to a partial model as a boundary condition.

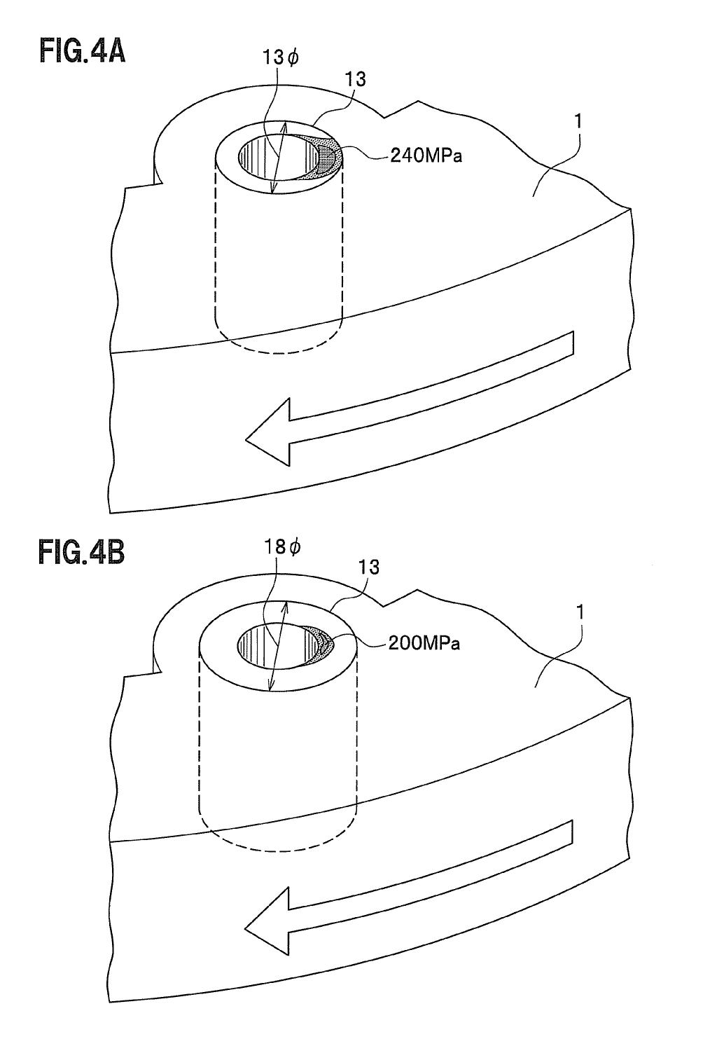

A calculation result of a torque stress distribution of the rotor main body 1 whose block body 13 has a diameter of 13 mm is shown in FIG. 4A, and a calculation result of the torque stress distribution of the rotor main body 1 whose block body 13 has the diameter of 18 mm is shown in FIG. 4A. Arrows in FIG. 4A and FIG. 4B indicate a rotation direction of the rotor main body 1, and a numerical number 1 indicates the rotor main body and a numerical number 13 indicates the block body.

As shown in FIG. 4A, a maximum value of the torque stress of the rotor main body 1 whose block body 13 has the outer diameter of 13 mm was 240 MPa. On the other hand, as shown in FIG. 4B, a maximum value of the torque stress of the rotor main body 1 whose block body 13 has the outer diameter of 18 mm was 200 MPa.

Namely, it was demonstrated that a torque stress and a torque strain during the braking decrease as the diameter of the block body 13 increases. In other words, it was demonstrated that the torque stress and the torque strain decrease as the volume of the block body 13 increases.

From the results of the foregoing simulation test, it was demonstrated that the rotor main body 1 having the block body 13 which is formed by winding carbon fibers in a cylindrical shape has a sufficient strength even if a large stress concentrates on the bolt joint when applied the brakes.

The embodiment of the present invention has been explained. However, the present invention is not limited to the foregoing embodiment, and can be embodied in various forms.

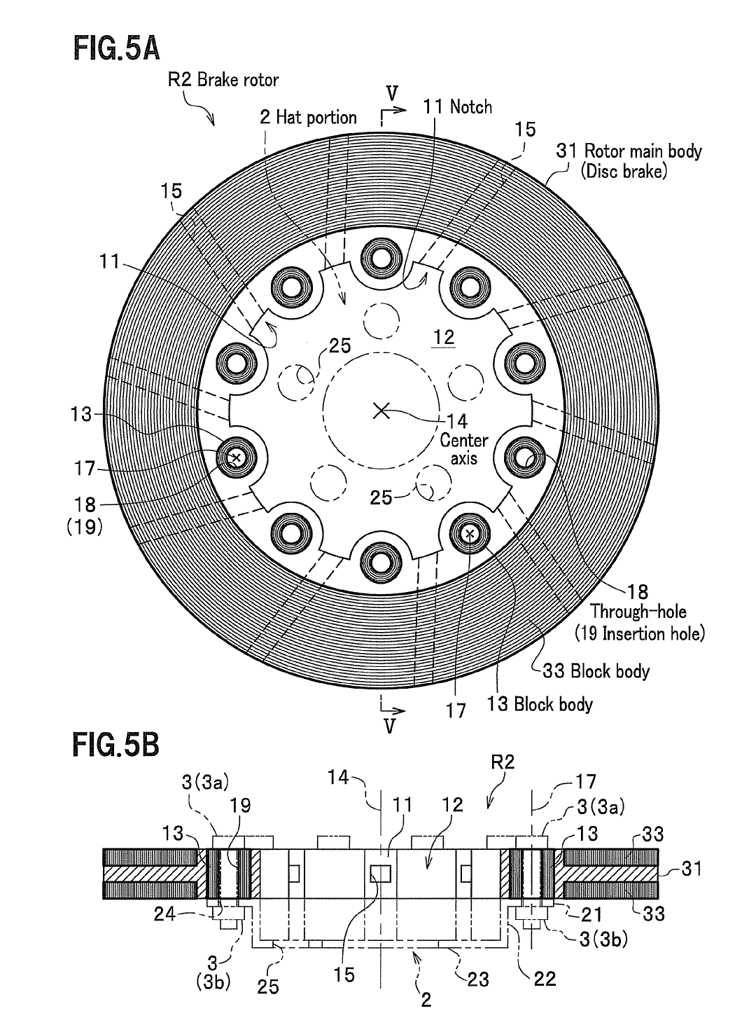

FIG. 5A, which is herein referred to, is a plane view of a brake rotor using a disc brake according to another embodiment of the present invention, and FIG. 5B is a cross sectional view of FIG. 5A taken along V-V line. Meanwhile, in FIG. 5A, the hat portion 2 is shown with imaginary lines, and a fastening tool for fastening the hat portion 2 to the rotor main body 1 is omitted for convenience of drawing. In addition, in FIG. 5B, the hat portion 2 and the fastening tool 3 (bolt 3a and nut 3b) are shown with imaginary lines. Furthermore, a component identical to that in the foregoing embodiment is given the same numerical number, and the explanation will be omitted.

As shown in FIG. 5A and FIG. 5B, in a rotor main body 31 of a bake rotor R2, a plurality of block bodies 13, which serve as the bolt joints, are arranged being embedded around the center axis 14 of the rotor main body 31 in a similar manner to those of the rotor main body 1 according to the foregoing embodiment.

In the rotor main body 31, as shown in FIG. 5A, a block body 33 is arranged being embedded in a ring shape area outside the block body 13.

The block body 33 is formed by winding carbon fibers (tape fiber bundle 16, see FIG. 2) formed in a tape so that the center axis 14 of the rotor main body 31 is a center of the winding, and as shown in FIG. 5B, the block body 33 is arranged on both front and back sides of the disc of the rotor main body 31.

Namely, in the rotor main body 31, the block body 33 is arranged on the disc surface to which the brake pad (not shown) is pressed.

In addition, as shown in FIG. 5B, the cooling hole 15 extends within the rotor main body 31 and between the block bodies 33, 33 on the front and back sides of the disc.

According to the rotor main body 31, since the block bodies 33 are arranged on the disc surfaces to which the brake pad (not shown) is pressed, strength of the disc surfaces to which the brake pad is pressed is further improved. As a result, according to the rotor main body 31, since the disc surfaces to which the brake pad is pressed is further improved by the block bodies 33 in addition to the improvement of strength of the bolt joints by the block bodies 13, a larger braking force can be applied to the rotor main body 1 by the collaboration of the block bodies 13 and the block bodies 33.

In addition, in the foregoing embodiment, the block body 13 is formed by winding a tape carbon fiber (fiber bundle) into a cylindrical shape. However, in the present invention, the block body 13 may be formed by winding a string of a fiber bundle, which is formed by carbon fibers, into a cylindrical shape.

In addition, in the foregoing embodiment, the rotor main body 1 (disc brake) which is used for the brake rotor R1 has been explained. However, the present invention may be applied to the disc brake to be used for a clutch disc. A bolt joint in this disc brake may be formed similar to the block body 13 which is provided with the insertion hole 19 of the bolt 3a, and also may be one where the block body 13 is arranged in a protruding spline portion.

In addition, in the foregoing embodiment, the rotor main body 1 which has the notch 11 has been explained. However, the rotor main body 1 according to the present invention may be the one which has no notch 11, that is, which has the center hole 12 of a true circle.

What is claimed is:

1. A disc brake made of a C/SiC composite material and provided with a bolt joint around a center axis of the disc brake,
wherein the bolt joint is formed by embedding a block body, which is formed by winding carbon fibers into a cylindrical shape, in the disc brake.

2. The disc brake according to claim 1,
wherein the block body is formed by winding a fiber bundle of the carbon fibers formed into a tape.

3. The disc brake according to claim 1,
wherein the block body is bored a through-hole at a center of the winding of the carbon fibers.

4. The disc brake according to claim 2,
wherein the block body is bored a through-hole at a center of the winding of the carbon fibers.

5. The disc brake according to claim 1,
wherein a surface of each of the carbon fibers is coated with a synthetic resin.

6. The disc brake according to claim 2,
wherein a surface of each of the carbon fibers is coated with a synthetic resin.

7. The disc brake according to claim 5,
wherein the synthetic resin comprises at least one of phenol resin, furan resin, polyimide resin, polyallylate resin, and polyurethane resin.

8. The disc brake according to claim 6,
wherein the synthetic resin comprises at least one of phenol resin, furan resin, polyimide resin, polyallylate resin, and polyurethane resin.

9. The disc brake according to claim 1,
wherein a mixture containing the carbon fibers each of whose surfaces is coated with the synthetic resin and an organic binder are filled in a die of the bolt joint where the block body is embedded.

10. The disc brake according to claim 2,
wherein a mixture containing the carbon fibers each of whose surfaces is coated with the synthetic resin and an organic binder are filled in a die of the bolt joint where the block body is embedded.

11. The disc brake according to claim 9,
wherein the organic binder comprises at least one of phenol resin, furan resin, imide resin, epoxy resin, pitch, and organosilicon-based polymer.

12. The disc brake according to claim 10,
wherein the organic binder comprises at least one of phenol resin, furan resin, imide resin, epoxy resin, pitch, and organosilicon-based polymer.

13. The disc brake according to claim 9,
wherein the mixture comprises at least one of granular graphite, silicon carbide, metallic carbide, and metallic nitride.

14. The disc brake according to claim 10,
wherein the mixture comprises at least one of granular graphite, silicon carbide, metallic carbide, and metallic nitride.
